(19) United States
(12) Patent Application Publication
(10) Pub. No.: US 2024/0272563 A1
(43) Pub. Date: Aug. 15, 2024

(54) CHARGING ROLL FOR ELECTROPHOTOGRAPHIC DEVICES AND METHOD FOR PRODUCING CHARGING ROLL FOR ELECTROPHOTOGRAPHIC DEVICES

(71) Applicant: Sumitomo Riko Company Limited, Aichi (JP)

(72) Inventors: Manami MURAI, Aichi (JP); Yoshihiro SAITO, Aichi (JP)

(73) Assignee: Sumitomo Riko Company Limited, Aichi (JP)

(21) Appl. No.: 18/629,938

(22) Filed: Apr. 9, 2024

Related U.S. Application Data
(63) Continuation of application No. PCT/JP2022/044507, filed on Dec. 2, 2022.

(30) Foreign Application Priority Data
Dec. 28, 2021 (JP) 2021-214583

(51) Int. Cl. G03G 15/02

(52) U.S. Cl. CPC G03G 15/0233

(57) ABSTRACT

A charging roll for electrophotographic devices is provided with: a shaft; an elastic body layer that is formed on the outer peripheral surface of the shaft; and a surface layer that is formed on the outer peripheral surface of the elastic body layer. The surface layer contains a binder polymer and metal oxide particles; and a part or the entirety of the surface of each of the metal oxide particles is covered by a fluorine-based anionic surface modification agent.

### CROSS-REFERENCE TO RELATED APPLICATION

The present application is a continuation of PCT/JP2022/044507, filed on Dec. 2, 2022, and is related to and claims priority from Japanese Patent Application No. 2021-214583 filed on Dec. 28, 2021. The entire contents of the aforementioned application are hereby incorporated by reference herein.

### TECHNICAL FIELD

The disclosure relates to a charging roll for electrophotographic device, which is suitably used in electrophotographic devices such as a copying machine, a printer, and a facsimile machine that employ an electrophotographic system.

### RELATED ART

A charging roll for electrophotographic device is known to have an elastic body layer having rubber elasticity on the outer peripheral surface of a shaft such as a core metal, and a surface layer on the outer peripheral surface of the elastic body layer. In the charging roll, roughness-forming particles or a conductive agent such as metal oxide particles may be added to a binder polymer in the surface layer in view of the charging properties, for example.

During printing, the charging roll rotates together with a photosensitive drum while being in contact with the photosensitive drum. The shear stress of the roll press rotation accompanying printing is applied to the interface between the materials that constitute the surface layer of the charging roll. Roughness-forming particles and metal oxide particles may be blended into the surface layer, but the interface between each particle and the binder polymer in the surface layer is large, so this interface receives particularly strong shear stress. The stress tends to concentrate on convex shapes caused by agglomeration of the metal oxide particles, and the binder polymer in the surface layer may be unable to withstand the shear stress, causing cracks to occur in the surface layer.

The disclosure provides a charging roll for electrophotographic device, which suppresses cracks in the surface layer due to the surface layer material.

### SUMMARY

A charging roll for electrophotographic device according to an embodiment of the disclosure includes: a shaft; an elastic body layer formed on an outer peripheral surface of the shaft; and a surface layer formed on an outer peripheral surface of the elastic body layer. The surface layer includes a binder polymer and metal oxide particles, and a part or entirety of a surface of the metal oxide particles is covered with a fluorine-based anionic surface modifier.

The surface layer may further include roughness-forming particles, and a part or entirety of a surface of the roughness-forming particles is covered with the fluorine-based anionic surface modifier. The fluorine-based anionic surface modifier may have a perfluoroalkyl group having 6 or less carbon atoms and a carboxylate group. The metal oxide particles may be tin oxide particles.

Further, a method for producing a charging roll for electrophotographic device according to an embodiment of the disclosure includes: mixing the metal oxide particles and the fluorine-based anionic surface modifier, and covering a part or entirety of the surface of the metal oxide particles with the fluorine-based anionic surface modifier; and mixing the metal oxide particles whose surface is partially or completely covered with the fluorine-based anionic surface modifier and the binder polymer.

A charging roll for electrophotographic device according to the disclosure includes a shaft; an elastic body layer formed on an outer peripheral surface of the shaft; and a surface layer formed on an outer peripheral surface of the elastic body layer. The surface layer includes a binder polymer and metal oxide particles, and a part or the entirety of the surface of the metal oxide particles is covered with a fluorine-based anionic surface modifier. Therefore, cracks in the surface layer due to the surface layer material are suppressed.

In the case where the surface layer further includes roughness-forming particles, when a part or the entirety of the surface of the roughness-forming particles is covered with the fluorine-based anionic surface modifier, the effect of suppressing cracks in the surface layer due to the surface layer material is improved.

In the case where the fluorine-based anionic surface modifier has a perfluoroalkyl group having 6 or less carbon atoms and a carboxylate group, the fluorine-based anionic surface modifier easily interacts with the surface functional groups of the metal oxide particles, making it easy to obtain the effect of the coating treatment.

In the case where the metal oxide particles are tin oxide particles, stable interaction is exhibited over a wide temperature range.

Further, a method for producing the charging roll for electrophotographic device according to the disclosure includes: mixing the metal oxide particles and the fluorine-based anionic surface modifier, and covering a part or entirety of the surface of the metal oxide particles with the fluorine-based anionic surface modifier; and mixing the metal oxide particles whose surface is partially or completely covered with the fluorine-based anionic surface modifier and the binder polymer. In the surface layer, a part or the entirety of the surface of the metal oxide particles is covered with the fluorine-based anionic surface modifier, so cracks in the surface layer due to the surface layer material are suppressed.

### BRIEF DESCRIPTION OF DRAWINGS

FIG. 1A is a schematic external view of a charging roll for electrophotographic device according to an embodiment of the disclosure, and FIG. 1B is a cross-sectional view thereof taken along the line A-A.

### DESCRIPTION OF EMBODIMENTS

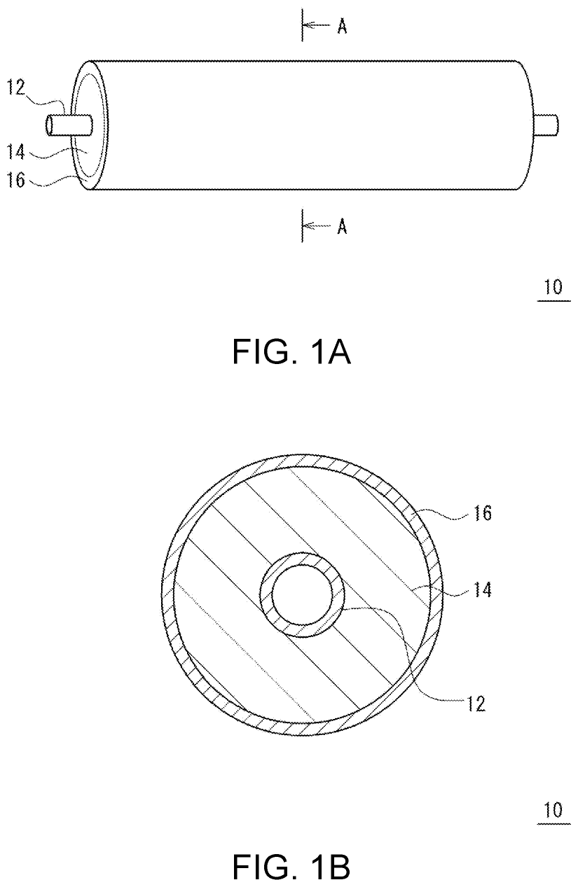

A charging roll for electrophotographic device (hereinafter may be simply referred to as charging roll) according to the disclosure will be described in detail. FIG. 1A is a schematic external view of the charging roll for electrophotographic device according to an embodiment of the disclosure, and FIG. 1B is a cross-sectional view thereof taken along the line A-A.

The charging roll 10 includes a shaft 12, an elastic body layer 14 formed on the outer peripheral surface of the shaft 12, and a surface layer 16 formed on the outer peripheral surface of the elastic body layer 14. The elastic body layer 14 is a layer (base layer) serving as the base of the charging roll 10. The surface layer 16 is a layer that appears on the surface of the charging roll 10. Although not particularly shown, an intermediate layer such as a resistance adjustment layer may be formed between the elastic body layer 14 and the surface layer 16 if necessary.

The shaft 12 is not particularly limited as long as the shaft 12 has conductivity. Specifically, a solid body made of metal such as iron, stainless steel, or aluminum, or a core metal made of a hollow body can be exemplified. An adhesive, a primer, or the like may be applied to the surface of the shaft 12 if necessary. In other words, the elastic body layer 14 may be adhered to the shaft 12 via an adhesive layer (primer layer). The adhesive, the primer, or the like may be conductive if necessary.

The elastic body layer 14 contains crosslinked rubber. The elastic body layer 14 is formed of a conductive rubber composition containing uncrosslinked rubber. The crosslinked rubber is obtained by crosslinking the uncrosslinked rubber. The uncrosslinked rubber may be polar rubber or non-polar rubber.

The polar rubber is rubber having a polar group, and examples of the polar group include a chloro group, a nitrile group, a carboxyl group, an epoxy group, and the like. Specifically, examples of the polar rubber include hydrin rubber, nitrile rubber (NBR), urethane rubber (U), acrylic rubber (a copolymer of acrylic acid ester and 2-chloroethyl vinyl ether, ACM), chloroprene rubber (CR), epoxidized natural rubber (ENR), and the like. Among the polar rubber, hydrin rubber and nitrile rubber (NBR) are more preferable from the viewpoint that the volume resistivity tends to be particularly low.

Examples of hydrin rubber include epichlorohydrin homopolymer (CO), epichlorohydrin-ethylene oxide binary copolymer (ECO), epichlorohydrin-allyl glycidyl ether binary copolymer (GCO), epichlorohydrin-ethylene oxide-allyl glycidyl ether terpolymer (GECO), and the like.

Examples of urethane rubber include polyether-type urethane rubber having an ether bond in the molecule. Polyether-type urethane rubber can be produced by reacting polyether having hydroxyl groups at both ends with diisocyanate. Examples of polyether include, but are not particularly limited to, polyethylene glycol, polypropylene glycol, and the like. Examples of diisocyanate include, but are not particularly limited to, tolylene diisocyanate, diphenylmethane diisocyanate, and the like.

Examples of the non-polar rubber include silicone rubber (Q), isoprene rubber (IR), natural rubber (NR), styrene butadiene rubber (SBR), butadiene rubber (BR), and the like. Among the non-polar rubber, isoprene rubber is more preferable from the viewpoint of excellent tensile properties.

Examples of the crosslinking agent include a sulfur crosslinking agent, a peroxide crosslinking agent, and a dechlorination crosslinking agent. These crosslinking agents may be used alone or in combination of two or more.

Examples of the sulfur crosslinking agent include conventionally known sulfur crosslinking agents such as powdered sulfur, precipitated sulfur, colloidal sulfur, surface-treated sulfur, insoluble sulfur, sulfur chloride, a thiuram-based vulcanization accelerator, polymeric polysulfide, and the like.

Examples of the peroxide crosslinking agent include conventionally known peroxide crosslinking agents such as peroxyketal, dialkyl peroxide, peroxy ester, ketone peroxide, peroxydicarbonate, diacyl peroxide, hydroperoxide, and the like.

Examples of the dechlorination crosslinking agent include a dithiocarbonate compound. More specifically, examples of the dechlorination crosslinking agent include quinoxaline-2,3-dithiocarbonate, 6-methylquinoxaline-2,3-dithiocarbonate, 6-isopropylquinoxaline-2,3-dithiocarbonate, 5,8-dimethylquinoxaline-2,3-dithiocarbonate, and the like.

From the viewpoint of preventing bleeding, the amount of the crosslinking agent to be mixed is preferably within the range of 0.1 to 2 parts by mass, more preferably within the range of 0.3 to 1.8 parts by mass, and even more preferably within the range of 0.5 to 1.5 parts by mass, based on 100 parts by mass of the uncrosslinked rubber.

In the case where the dechlorination crosslinking agent is used as the crosslinking agent, a dechlorination crosslinking accelerator may be used in combination. Examples of the dechlorination crosslinking accelerator include 1,8-diazabicyclo(5,4,0)undecene-7 (hereinafter abbreviated as DBU) or weak acid salt thereof. The dechlorination crosslinking accelerator may be used in the form of DBU, but from the viewpoint of handling, the dechlorination crosslinking accelerator is preferably used in the form of weak acid salt thereof. Examples of the weak acid salt of DBU include carbonate, stearate, 2-ethylhexylate, benzoate, salicylate, 3-hydroxy-2-naphthoate, phenol resin salt, 2-mercaptobenzothiazole salt, 2-mercaptobenzimidazole salt, and the like.

From the viewpoint of preventing bleeding, the content of the dechlorination crosslinking accelerator is preferably within the range of 0.1 to 2 parts by mass based on 100 parts by mass of the uncrosslinked rubber. The content of the dechlorination crosslinking accelerator is more preferably within the range of 0.3 to 1.8 parts by mass, and even more preferably within the range of 0.5 to 1.5 parts by mass.

A conductive agent can be added to the elastic body layer 14 to impart conductivity. Examples of the conductive agent include an electronic conductive agent and an ionic conductive agent. Examples of the electronic conductive agent include carbon black, graphite, and conductive metal oxide. Examples of the conductive metal oxide include conductive titanium oxide, conductive zinc oxide, conductive tin oxide, and the like. Examples of the ionic conductive agent include quaternary ammonium salt, borate, a surfactant, and the like. Further, various additives may be added to the elastic body layer 14 if necessary. Examples of the additives include lubricants, vulcanization accelerators, anti-aging agents, light stabilizers, viscosity modifiers, processing aids, flame retardants, plasticizers, foaming agents, fillers, dispersants, anti-foaming agents, pigments, release agents, and the like.

The elastic body layer 14 can be adjusted to have a predetermined volume resistivity by adjusting the type of the crosslinked rubber, the amount of the ionic conductive agent to be mixed, the amount of the electronic conductive agent, and the like. The volume resistivity of the elastic body layer 14 may be appropriately set within the range of 10² to 10¹⁰ Ω·cm, 10³ to 10⁹ Ω·cm, 10⁴ to 10⁸ Ω·cm, or the like, depending on the application.

The thickness of the elastic body layer 14 is not particularly limited, and may be appropriately set within the range of 0.1 to 10 mm depending on the application.

The surface layer 16 includes a binder polymer and metal oxide particles. The surface layer 16 may further include roughness-forming particles.

The binder polymer is a base polymer that constitutes the surface layer 16. Examples of the binder polymer include urethane resin, polyamide resin, acrylic resin, acrylic silicone resin, butyral resin (PVB), alkyd resin, polyester resin, fluororubber, fluororesin, a mixture of fluororubber and fluororesin, silicone resin, a silicone-grafted acrylic polymer, an acrylic-grafted silicone polymer, nitrile rubber, urethane rubber, and the like.

As the binder polymer, a polymer having a carbonyl group is preferable. This is because a polymer having a carbonyl group is a material with a relatively high dielectric constant, allowing the charging roll 10 to easily ensure excellent chargeability. Examples of the polymer having a carbonyl group include urethane resin, polyamide resin, acrylic resin, acrylic silicone resin, a silicone-grafted acrylic polymer, an acrylic-grafted silicone polymer, urethane rubber, and the like. Among these, from the viewpoint of excellent wear resistance, polyamide resin, acrylic resin, acrylic silicone resin, a silicone-grafted acrylic polymer, and an acrylic-grafted silicone polymer are particularly preferable. The polyamide resin may be modified. Examples of the modified polyamide include alkoxylated polyamide such as N-methoxymethylated nylon, and the like.

The metal oxide particles function as a conductive agent for the surface layer 16. The metal oxide particles are conductive metal oxide particles. A part or the entirety of the surface of the metal oxide particles in the surface layer 16 is covered with a fluorine-based anionic surface modifier. A part of the surface of the metal oxide particles may be covered with a fluorine-based anionic surface modifier, or the entire surface may be covered with a fluorine-based anionic surface modifier. A part of the surface refers to preferably 30% or more of the surface of the metal oxide particles in terms of area, more preferably 50% or more, and even more preferably 70% or more. In the case where a part of the surface is covered, the portion covered with the fluorine-based anionic surface modifier needs to be dispersed over the entire surface of the metal oxide particles.

Polar functional groups such as hydroxyl groups and carboxyl groups are present on the surface of the metal oxide particles. The fluorine-based anionic surface modifier can cover the surface of the metal oxide particles through electrostatic interaction between the anionic groups thereof and the functional groups on the surface of the metal oxide particles, which suppresses agglomeration of the metal oxide particles. At this time, the fluorine-containing groups thereof are oriented toward the outside of the metal oxide particles. The fluorine-containing groups oriented on the surface of the metal oxide particles toward the outside of the metal oxide particles reduce the friction at the interface between the metal oxide particles and the binder polymer, thereby alleviating the shear stress applied to the binder polymer. These suppress cracks in the surface layer 16 caused by the surface layer material. If the surface modifier is cationic or nonionic rather than anionic, the surface modifier cannot interact with the functional groups on the surface of the metal oxide particles and cannot cover the surface of the metal oxide particles. Furthermore, if the surface modifier is not a fluorine-based agent but a silicone-based agent, the effect of reducing the friction at the interface between the metal oxide particles and the binder polymer is not sufficient. In addition, if carbon black is used instead of metal oxide particles, the surface functional groups of carbon black are less likely to interact with the fluorine-based anionic surface modifier, so the fluorine-based anionic surface modifier cannot cover the surface of carbon black well.

The metal oxide particles are not particularly limited as long as the metal oxide particles have excellent conductivity. Examples of the metal oxide particles include tin oxide particles, zinc oxide particles, indium oxide particles, titanium oxide particles, and the like. Among these, tin oxide particles are particularly preferable from the viewpoint of exhibiting stable interaction over a wide temperature range.

The particle diameter (primary particle diameter) of the metal oxide particles is not particularly limited, but is preferably 0.001 μm or more and 0.5 μm or less from the viewpoint of image uniformity. The particle diameter is more preferably 0.005 μm or more and 0.1 μm or less. Further, the diameter of the aggregate (secondary particle diameter) of the metal oxide particles is preferably 0.002 μm or more and 0.7 μm or less from the viewpoint of dispersibility. The diameter of the aggregate is more preferably 0.6 μm or less. The diameter of the aggregate of the metal oxide particles can be kept small by covering the surface of the metal oxide particles with the fluorine-based anionic surface modifier.

The content of the metal oxide particles in the surface layer 16 is preferably 30 parts by mass or more based on 100 parts by mass of the binder polymer from the viewpoint of conductivity. The content is more preferably 50 parts by mass or more, and even more preferably 70 parts by mass or more. Furthermore, the content of the metal oxide particles in the surface layer 16 is preferably 200 parts by mass or less based on 100 parts by mass of the binder polymer from the viewpoint of stress dispersibility. The content is more preferably 150 parts by mass or less.

The fluorine-based anionic surface modifier is used for the purposes of covering the surface of the metal oxide particles to suppress agglomeration of the metal oxide particles, modify the surface of the metal oxide particles, etc. In addition, in the case where the surface layer 16 includes roughness-forming particles, the fluorine-based anionic surface modifier is used for the purposes of covering the surface of the roughness-forming particles to suppress agglomeration of the roughness-forming particles, suppress interaction between the roughness-forming particles and the metal oxide particles, modify the surface of the roughness-forming particles, etc.

The fluorine-based anionic surface modifier has an anionic group. Examples of the anionic group include a carboxylate group (—COO⁻), a sulfonate group (—SO₄²⁻), a phosphoric acid group, and the like. Among these, a carboxylate group is particularly preferable from the viewpoint of excellent balance of interaction with the functional groups on the surface of the metal oxide.

The fluorine-based anionic surface modifier is composed of a compound having a fluorine-containing organic group (a compound having a fluorine-containing group). Examples of the fluorine-containing group include a fluoroalkyl group having 1 to 20 carbon atoms. The fluoroalkyl group may be a perfluoroalkyl group in which all hydrogen atoms of the alkyl group are substituted with fluorine atoms, or may be a fluoroalkyl group in which some hydrogen atoms of the alkyl group are substituted with fluorine atoms. Among these, a perfluoroalkyl group is more preferable from the viewpoint of having an excellent effect of modifying the surface of the metal oxide particles with the fluorine-containing group. Further, the fluorine-containing group preferably has 6 carbon atoms or less. More preferably, the fluorine-containing group has 1 to 6 carbon atoms, and more preferably 2 to 6 carbon atoms. If the number of carbon atoms in the fluorine-containing group is 8 or more, there is a strong concern about environmental regulations, so the number of carbon atoms in the fluorine-containing group is preferably 6 or less. Furthermore, the number of carbon atoms in the fluorine-containing group is preferably 2 or more, which has an excellent effect of lowering surface tension.

The fluorine-based anionic surface modifier preferably has one or more fluorine-containing groups in the molecule, but is particularly preferable to have one fluorine-containing group in the molecule from the viewpoint of less steric hindrance when the surface modifier is oriented on the surface of the metal oxide particles during coating treatment and excellent coating efficiency. In addition, the fluorine-based anionic surface modifier preferably has one or more anionic groups in the molecule, but is particularly preferable to have one anionic group in the molecule from the viewpoint of excellent uniformity of interaction with the metal oxide particles.

The fluorine-based anionic surface modifier may be a monomolecule or a polymer. The fluorine-based anionic surface modifier is preferably a monomolecule rather than a polymer from the viewpoint of less hindrance when the surface modifier is oriented on the surface of the metal oxide particles during coating treatment. The molecular weight (number average molecular weight) of the fluorine-based anionic surface modifier is preferably 400 or more from the viewpoint of stability of the interaction state. The molecular weight is more preferably 500 or more, and even more preferably 1,000 or more. Further, the molecular weight (number average molecular weight) of the fluorine-based anionic surface modifier is preferably less than 3,000 from the viewpoint of the number of reactive groups. The molecular weight is more preferably 2,500 or less, and even more preferably 2,000 or less.

The amount of the fluorine-based anionic surface modifier is preferably 0.1 parts by mass or more and 5.0 parts by mass or less based on 100 parts by mass of the metal oxide particles. The amount is more preferably 0.3 parts by mass or more and 3.0 parts by mass or less, and even more preferably 0.5 parts by mass or more and 3.0 parts by mass or less. Moreover, in the case where the surface layer 16 further includes roughness-forming particles, the amount of the fluorine-based anionic surface modifier is preferably 0.1 parts by mass or more and 5.0 parts by mass or less based on 100 parts by mass of the metal oxide particles. The amount is more preferably 0.3 parts by mass or more and 3.0 parts by mass or less, and even more preferably 0.5 parts by mass or more and 3.0 parts by mass or less. Furthermore, in the case where the surface layer 16 further includes roughness-forming particles, the total amount of the fluorine-based anionic surface modifier is preferably 5.0 parts by mass or less based on 100 parts by mass of the metal oxide particles.

The roughness-forming particles are particles for imparting roughness to the surface of the surface layer 16. In other words, the roughness-forming particles are particles for imparting irregularities to the surface of the surface layer 16. The surface irregularities of the surface layer 16 increase the discharge space between a photoreceptor and the charging roll 10 and promote discharge, thereby improving the chargeability and suppressing image defects such as horizontal streaks and unevenness.

Resin particles, inorganic particles, and the like are used as the roughness-forming particles. The material of the roughness-forming particles is not particularly limited. The roughness-forming particles are preferably composed of a polymer having a carbonyl group. This is because a polymer having a carbonyl group is a material with a relatively high dielectric constant, allowing the charging roll 10 to easily ensure excellent chargeability. Examples of the polymer having a carbonyl group include urethane resin, polyamide resin, acrylic resin, acrylic silicone resin, a silicone-grafted acrylic polymer, an acrylic-grafted silicone polymer, urethane rubber, and the like. Among these, from the viewpoint of excellent wear resistance, polyamide resin, acrylic resin, acrylic silicone resin, a silicone-grafted acrylic polymer, and an acrylic-grafted silicone polymer are particularly preferable.

A part or the entirety of the surface of the roughness-forming particles is preferably covered with the fluorine-based anionic surface modifier. When the surface of the roughness-forming particles is covered with the fluorine-based anionic surface modifier, the interaction between the polar functional groups present on the surface of the roughness-forming particles and the functional groups on the surface of the metal oxide particles is reduced, the metal oxide particles are less likely to gather on the surface of the roughness-forming particles, stress concentration due to agglomeration of the metal oxide particles on the surface of the roughness-forming particles is suppressed, and the occurrence of cracks due to shear stress in the binder polymer of the surface layer 16 is easily suppressed. Since the friction on the surface of the roughness-forming particles is also reduced, the occurrence of cracks due to shear stress at the interface between the roughness-forming particles and the binder polymer is also suppressed. A part of the surface refers to preferably 30% or more of the surface of the roughness-forming particles in terms of area, more preferably 50% or more, and even more preferably 70% or more. In the case where a part of the surface is covered, the portion covered with the fluorine-based anionic surface modifier needs to be dispersed over the entire surface of the roughness-forming particles.

The fluorine-based anionic surface modifier that covers the surface of the roughness-forming particles is the same as the fluorine-based anionic surface modifier used for covering the surface of the metal oxide described above. The fluorine-based anionic surface modifier that covers the surface of the roughness-forming particles may be the same as or different from the fluorine-based anionic surface modifier that covers the surface of the metal oxide.

The size of the roughness-forming particles is not particularly limited, but from the viewpoint of easily ensuring uniform chargeability, the average particle diameter is preferably 3.0 μm or more and 50 μm or less. More preferably, the average particle diameter is 5.0 μm or more and 30 μm or less. The average particle diameter of the roughness-forming particles is expressed as the average of 20 arbitrary points when the surface of the surface layer 16 is observed with a laser microscope, and the diameter of the roughness-forming particles 16 that can be seen during surface observation is defined as the particle diameter.

The content of the roughness-forming particles in the surface layer 16 is not particularly limited, but from the viewpoint of easily ensuring uniform chargeability, the content is preferably 3 parts by mass or more and 50 parts by mass or less based on 100 parts by mass of the binder polymer of the surface layer 16. The content is more preferably 5 parts by mass or more and 30 parts by mass or less.

Various additives may be added to the surface layer 16 if necessary. Examples of the additives include plasticizers, leveling agents, fillers, vulcanization accelerators, processing aids, release agents, and the like.

The volume resistivity of the surface layer 16 is preferably set in a semiconductive region from the viewpoint of chargeability. Specifically, the volume resistivity may be set within the range of 1.0×10⁷ to 1.0×10¹⁰ Ω·cm, for example. Volume resistivity can be measured in accordance with JIS K6911. The thickness of the surface layer 16 is not particularly limited, and is preferably set within the range of 0.1 to 30 μm. The thickness of the surface layer 16 can be measured by observing the cross section using a laser microscope (for example, “VK-9510” or the like manufactured by Keyence Corporation). For example, the distance from the surface of the elastic body layer 14 to the surface of the surface layer 16 can be measured at five arbitrary positions, and the thickness can be expressed as the average of the distances.

The elastic body layer 14 can be formed, for example, as follows. First, the shaft 12 is coaxially installed in the hollow part of a roll molding die, and an uncrosslinked conductive rubber composition is injected. After heating and curing (crosslinking), the elastic body layer 14 is formed on the outer periphery of the shaft 12 by demolding or by extruding the uncrosslinked conductive rubber composition on the surface of the shaft 12.

The surface layer 16 can be formed by applying the material forming the surface layer 16 onto the outer peripheral surface of the elastic body layer 14 and appropriately performing a drying treatment or the like. The material forming the surface layer 16 may include a diluting solvent. Examples of the diluting solvent include ketone solvents such as methyl ethyl ketone (MEK) and methyl isobutyl ketone, alcohol solvents such as isopropyl alcohol (IPA), methanol, and ethanol, hydrocarbon solvents such as hexane and toluene, acetic acid solvents such as ethyl acetate and butyl acetate, ether solvents such as diethyl ether and tetrahydrofuran, water, and the like.

The material forming the surface layer 16 includes the binder polymer and the metal oxide particles. The material forming the surface layer 16 may further include roughness-forming particles if necessary. As described above, a part or the entirety of the surface of the metal oxide particles is covered with the fluorine-based anionic surface modifier. Further, as described above, a part or the entirety of the surface of the roughness-forming particles is covered with the fluorine-based anionic surface modifier.

The material forming the surface layer 16 may be prepared as follows. First, the metal oxide particles and the fluorine-based anionic surface modifier are mixed, and a part or the entirety of the surface of the metal oxide particles is covered with the fluorine-based anionic surface modifier. Next, the metal oxide particles whose surface is partially or completely covered with the fluorine-based anionic surface modifier is mixed with the binder polymer. In this way, the metal oxide particles are first mixed with the fluorine-based anionic surface modifier before being mixed with the binder polymer, making it possible to cover a part or the entirety of the surface of the metal oxide particles with the fluorine-based anionic surface modifier.

In the case where the material forming the surface layer 16 includes the roughness-forming particles, the roughness-forming particles may also be mixed with the fluorine-based anionic surface modifier before being mixed with the binder polymer. Thereby, a part or the entirety of the surface of the roughness-forming particles can be covered with the fluorine-based anionic surface modifier. In the case where the surface of the roughness-forming particles is also covered with the fluorine-based anionic surface modifier, the metal oxide particles and the roughness-forming particles may be mixed together with the fluorine-based anionic surface modifier before being mixed with the binder polymer, or may be mixed separately with the fluorine-based anionic surface modifier. In the case where the metal oxide particles and the roughness-forming particles are mixed separately, the effect of covering the surface of each particle and the effect of suppressing agglomeration of the metal oxide particles on the surface of the roughness-forming particles are enhanced.

According to the charging roll 10 having the above configuration, a part or the entirety of the surface of the metal oxide particles contained in the surface layer 16 is covered with the fluorine-based anionic surface modifier, so agglomeration of the metal oxide particles is suppressed. In addition, the fluorine-containing groups oriented toward the outside of the metal oxide particles reduce the friction at the interface between the metal oxide particles and the binder polymer, thereby alleviating the shear stress applied to the binder polymer. As a result, cracks in the surface layer 16 caused by the surface layer material are suppressed.

When agglomeration of the metal oxide particles is suppressed, the resistance unevenness of the surface layer 16 is reduced. The resistance unevenness of the surface layer 16 is determined by randomly measuring the resistance at 100 points on the surface of the surface layer 16 using AFM, and can be expressed as the ratio of the difference between the maximum and minimum resistance values to the average resistance value of 100 points ((maximum resistance value-minimum resistance value)/average resistance value). The above ratio decreases to about 15% in the case where a part or the entirety of the surface of the metal oxide particles included in the surface layer 16 is covered with the fluorine-based anionic surface modifier, and increases to about 30% in the case where a part or the entirety of the surface of the metal oxide particles included in the surface layer 16 is not covered with the fluorine-based anionic surface modifier (in the case where the resistance unevenness is large).

Moreover, as a part or the entirety of the surface of the roughness-forming particles included in the surface layer 16 is covered with the fluorine-based anionic surface modifier, the metal oxide particles are less likely to gather on the surface of the roughness-forming particles, stress concentration due to agglomeration of the metal oxide particles on the surface of the roughness-forming particles is suppressed, and the occurrence of cracks due to shear stress in the binder polymer of the surface layer 16 is easily suppressed. Further, since the friction on the surface of the roughness-forming particles is also reduced, the occurrence of cracks due to shear stress at the interface between the roughness-forming particles and the binder polymer is also suppressed.

### EXAMPLES

Hereinafter, the disclosure will be described in detail using Examples and Comparative Examples.

### Example 1

### Preparation of Elastic Body Layer Composition

5 parts by mass of a vulcanization aid (zinc oxide, “zinc oxide 2 type” manufactured by Mitsui Kinzoku), 10 parts by mass of carbon (“Ketjenblack EC300J” manufactured by Ketjen Black International), 0.5 parts by mass of a vulcanization accelerator (2-mercaptobenzothiazole, “Noxeller M-P” manufactured by Ouchi Shinko Chemical Industrial Co., Ltd.), 2 parts by mass of sulfur (“Sulfax PTC” manufactured by Tsurumi Chemical Industry Co., Ltd.), and 50 parts by mass of a filler (calcium carbonate, “HAKUENKA CC” manufactured by Shiraishi Kogyo Kaisha, Ltd.) were added to 100 parts by mass of hydrin rubber (ECO, “Epichromer CG102” manufactured by Daiso Co., Ltd.), and these were stirred and mixed with a stirrer to prepare a conductive rubber composition.

### Preparation of Elastic Body Layer

A shaft (diameter 8 mm) made of a nickel-plated iron core metal was set in a molding die (pipe shape), the above elastic body layer composition was injected, and after heating at 180° C. for 30 minutes, cooling and demolding were performed to form an elastic body layer composed of a conductive rubber elastic body with a thickness of 1.9 mm on the outer periphery of the core metal.

### Particle Coating Treatment

0.7 parts by mass of a fluorine-based anionic surface modifier was blended with 100 parts by mass of metal oxide, 100 parts by mass of MEK was added, and the mixture was stirred at 40° C. or lower for 30 minutes. Through the above, metal oxide coated with the fluorine-based anionic surface modifier was obtained.

In addition, 0.3 parts by mass of the fluorine-based anionic surface modifier was blended with 50 parts by mass of roughness-forming particles (“ORGASOL 2001 UD NAT 1” manufactured by Arkema), 50 parts by mass of MEK was added, and the mixture was stirred at 40° C. or lower for 30 minutes. Through the above, roughness-forming particles coated with the fluorine-based anionic surface modifier were obtained.

### Preparation of Surface Layer

50 parts by mass of melamine resin, 100 parts by mass of metal oxide particles coated with the fluorine-based anionic surface modifier, and 50 parts by mass of the roughness-forming particles coated with the fluorine-based anionic surface modifier were blended with 100 parts by mass of polyamide resin (binder polymer), and 100 parts by mass of MEK was mixed to prepare a surface layer forming composition. Next, the surface layer forming composition was roll coated on the outer peripheral surface of the elastic body layer, and heat treatment was performed to form a surface layer with a thickness of 10 um on the outer periphery of the elastic body layer. In this way, a charging roll was produced.

### Examples 2 to 8 and 10

The surface layer material was composed of the compounding composition shown in Table 1.

### Example 9

In the elastic body layer composition, the base polymer was changed from hydrin rubber to isoprene rubber (IR, “JSR IR2200” manufactured by JSR).

### Comparative Example 1

The charging roll was produced in the same manner as in Example 1 except that the surface layer material was not coated with metal oxide particles.

### Comparative Example 2

The charging roll was produced in the same manner as in Example 1 except that carbon black was used as the conductive agent in place of the metal oxide particles in the surface layer material.

### Comparative Example 3

The charging roll was produced in the same manner as in Comparative Example 2 except that the surface layer material was not coated with carbon black as a conductive agent.

### Comparative Examples 4 to 7

The charging roll was produced in the same manner as in Example 10 except that the surface modifier was changed in the surface layer material.

The materials used for the surface layer are as follows.
Metal oxide particles <1>: conductive tin oxide, (“SN-100P” manufactured by Ishihara Sangyo Kaisha, Ltd.), average particle diameter 0.01 to 0.03 μm
Metal oxide particles <2>: conductive zinc oxide, (“Pazet GK-40” manufactured by Hakusui Tech), average particle diameter 0.02 to 0.04 μm
Carbon black: (“SHOBLACK N762” manufactured by Cabot Japan)
Surface modifier <1>: fluorine-based, anionic (containing carboxylate group), (“Megafac F-410” manufactured by DIC)
Surface modifier <2>: fluorine-based, anionic (containing sulfonate group), (“Ftergent 110” manufactured by NEOS)
Surface modifier <3>: fluorine-based, cationic (containing quaternary ammonium group), (“Ftergent 300” manufactured by NEOS)
Surface modifier <4>: fluorine-based, nonionic, (“Megafac F-554” manufactured by DIC)
Surface modifier <5>: carboxyl group-containing silicone-based surface modifier (“X-22-3710” manufactured by Shin-Etsu Silicone) saponified with sodium hydroxide to have an anionic group (carboxylate group)
Roughness-forming particles <1>: made of polyurethane, (“Art Pearl C-800T” manufactured by Negami Kogyo), average particle diameter 6 μm
Roughness-forming particles <2>: made of polyamide, (“ORGASOL 2001 UD NAT 1” manufactured by Arkema), average particle diameter 5 μm
Binder polymer <1>: polyamide, (“Fine Resin FR-101” manufactured by Namariichi)
Binder polymer <2>: polyurethane, (urethane resin, “Nipporan 5196” manufactured by Tosoh)

The generation of cracks in the surface layer was investigated using the prepared charging roll.

### Image Evaluation

The prepared charging roll was attached to the unit (black) of an actual machine (“MP C6004” manufactured by RICOH), and an evaluation (streak evaluation) was carried out after printing 500,000 sheets of images at 25% density halftone in an environment of 10° C. and 10% RH. An example in which no streak image was generated due to cracks in the surface layer was rated as “O”, and an example in which a streak image was generated due to cracks in the surface layer was rated as “X”.

TABLE 1

| | | | Example | | | | | | | | | | Comparative Example | | | | | | |
|---|---|---|---|---|---|---|---|---|---|---|---|---|---|---|---|---|---|---|---|
| | | | 1 | 2 | 3 | 4 | 5 | 6 | 7 | 8 | 9 | 10 | 1 | 2 | 3 | 4 | 5 | 6 | 7 |
| Elastic | Base | ECO | 100 | 100 | 100 | 100 | 100 | 100 | 100 | 100 | — | 100 | 100 | 100 | 100 | 100 | 100 | 100 | 100 |
| body | polymer | IR | — | — | — | — | — | — | — | — | 100 | — | — | — | — | — | — | — | — |
| layer | | | | | | | | | | | | | | | | | | | |
| Surface | Binder | Polyamide | 100 | — | 100 | 100 | 100 | 100 | — | 100 | — | 100 | 100 | 100 | 100 | 100 | 100 | 100 | 100 |
| layer | polymer | Polyurethane | — | 100 | — | — | — | — | 100 | — | 100 | — | — | — | — | — | — | — | — |
| | Conductive | <1> | 100 | 100 | 100 | — | 100 | 100 | 100 | — | 100 | 100 | 100 | — | — | 100 | 100 | 100 | 100 |
| | agent | Tin oxide | | | | | | | | | | | | | | | | | |
| | | <2> | — | — | — | 100 | — | — | — | 100 | — | — | — | — | — | — | — | — | — |
| | | Zinc oxide | | | | | | | | | | | | | | | | | |
| | | Carbon | — | — | — | — | — | — | — | — | — | — | — | 100 | 100 | — | — | — | — |
| | | black | | | | | | | | | | | | | | | | | |
| | | Coating | Yes | Yes | Yes | Yes | Yes | Yes | Yes | Yes | Yes | Yes | No | Yes | No | Yes | Yes | Yes | Yes |
| | | treatment | | | | | | | | | | | | | | | | | |
| | | Coating | 0.7 | 3.5 | 1.0 | 0.7 | 0.7 | 3.5 | 0.7 | 5.0 | 5.0 | 1.0 | 0 | 0.7 | 0 | 1.0 | 5.0 | 1.0 | 1.0 |
| | | amount | | | | | | | | | | | | | | | | | |
| | Roughness- | <1> | 50 | 50 | 50 | 50 | 10 | — | 50 | 50 | — | — | 50 | 50 | 50 | — | — | — | — |
| | | Polyurethane | | | | | | | | | | | | | | | | | |
| | forming | <2> | — | — | — | — | — | 50 | — | — | 50 | — | — | — | — | — | — | — | — |
| | particles | Polyamide | | | | | | | | | | | | | | | | | |
| | | Coating | Yes | Yes | No | Yes | Yes | Yes | Yes | No | No | — | Yes | Yes | Yes | — | — | — | — |
| | | treatment | | | | | | | | | | | | | | | | | |
| | | Coating | 0.3 | 1.5 | 0 | 0.3 | 0.3 | 1.5 | 0.3 | 0 | 0 | — | 1.0 | 0.3 | 1.0 | — | — | — | — |
| | | amount | | | | | | | | | | | | | | | | | |
| | Surface | <1> F— | 1.0 | 5.0 | 1.0 | 1.0 | 1.0 | 5.0 | — | — | — | 1.0 | 1.0 | 1.0 | 1.0 | — | — | — | — |
| | modifier | based | | | | | | | | | | | | | | | | | |
| | (total | anionic | | | | | | | | | | | | | | | | | |
| | amount) | (—COO⁻) | | | | | | | | | | | | | | | | | |
| | | <2> F— | — | — | — | — | — | — | 1.0 | 5.0 | 5.0 | — | — | — | — | — | — | — | — |
| | | based | | | | | | | | | | | | | | | | | |
| | | anionic | | | | | | | | | | | | | | | | | |
| | | (—SO₄²⁻) | | | | | | | | | | | | | | | | | |
| | | <3> F— | — | — | — | — | — | — | — | — | — | — | — | — | — | 1.0 | 5.0 | — | — |
| | | based | | | | | | | | | | | | | | | | | |
| | | cationic | | | | | | | | | | | | | | | | | |
| | | (NR₄⁺) | | | | | | | | | | | | | | | | | |
| | | <4> F— | — | — | — | — | — | — | — | — | — | — | — | — | — | — | — | 1.0 | — |
| | | based | | | | | | | | | | | | | | | | | |
| | | nonionic | | | | | | | | | | | | | | | | | |
| | | <5> Si— | — | — | — | — | — | — | — | — | — | — | — | — | — | — | — | — | 1.0 |
| | | based | | | | | | | | | | | | | | | | | |
| | | anionic | | | | | | | | | | | | | | | | | |
| | | (—COO⁻) | | | | | | | | | | | | | | | | | |

| | | | | | | | | | | | | | | | | | | |
|---|---|---|---|---|---|---|---|---|---|---|---|---|---|---|---|---|---|---|
| Evaluation | Streak image | ◯ | ◯ | ◯ | ◯ | ◯ | ◯ | ◯ | ◯ | ◯ | ◯ | X | X | X | X | X | X | X |

In Comparative Example 1, the surface of the metal oxide particles was not coated with a surface modifier. Therefore, agglomeration of the metal oxide particles was not suppressed, and cracks in the surface layer due to the surface layer material were not suppressed. In Comparative Examples 2 and 3, the conductive agent was carbon black. In Comparative Example 2, carbon black was surface-treated using a surface modifier, but the surface functional groups of carbon black had difficulty interacting with the surface modifier, so the coating treatment was not effective and agglomeration was not suppressed. Therefore, in Comparative Example 2, cracks in the surface layer due to the surface layer material were not suppressed. In Comparative Example 3, the surface of carbon black was not coated with a surface modifier. Therefore, agglomeration of carbon black was not suppressed, and cracks in the surface layer due to the surface layer material were not suppressed.

In Comparative Examples 4 and 5, the surface modifier was a fluorine-based cationic surface modifier. Moreover, in Comparative Example 6, the surface modifier was a fluorine-based nonionic surface modifier. In Comparative Examples 4 to 6, the surface modifier did not interact with the surface functional groups of the metal oxide particles, so the metal oxide particles were not coated with the surface modifier, and agglomeration of the metal oxide particles was not suppressed. Therefore, in Comparative Examples 4 to 6, cracks in the surface layer due to the surface layer material were not suppressed. In Comparative Example 7, the surface modifier was a silicone-based anionic surface modifier. In Comparative Example 7, although the metal oxide particles were coated with the surface modifier, there was no fluorine-containing group oriented toward the outside of the metal oxide particles, so the effect of reducing the friction at the interface between the metal oxide particles and the binder polymer was insufficient, and cracks in the surface layer due to the surface layer material were not suppressed.

In contrast thereto, in the examples, the metal oxide particles were used as the conductive agent, and the surface of the metal oxide particles was covered with the fluorine-based anionic surface modifier. Therefore, agglomeration of the metal oxide particles was suppressed. In addition, the fluorine-containing groups oriented toward the outside of the metal oxide particles reduced the friction at the interface between the metal oxide particles and the binder polymer, and alleviated the shear stress applied to the binder polymer. As a result, cracks in the surface layer caused by the surface layer material were suppressed.

Although the embodiments and examples of the disclosure have been described above, the disclosure is not limited to the above embodiments and examples, and various modifications can be made without departing from the spirit of the disclosure.

What is claimed is:

1. A charging roll for electrophotographic device, comprising:
a shaft;
an elastic body layer formed on an outer peripheral surface of the shaft; and
a surface layer formed on an outer peripheral surface of the elastic body layer,
wherein the surface layer comprises a binder polymer and metal oxide particles, and
a part or entirety of a surface of the metal oxide particles is covered with a fluorine-based anionic surface modifier.

2. The charging roll for electrophotographic device according to claim 1, wherein the surface layer further comprises roughness-forming particles, and a part or entirety of a surface of the roughness-forming particles is covered with the fluorine-based anionic surface modifier.

3. The charging roll for electrophotographic device according to claim 1, wherein the fluorine-based anionic surface modifier has a perfluoroalkyl group having 6 or less carbon atoms and a carboxylate group.

4. The charging roll for electrophotographic device according to claim 1, wherein the metal oxide particles are tin oxide particles.

5. A method for producing the charging roll for electrophotographic device according to claim 1, the method comprising:
mixing the metal oxide particles and the fluorine-based anionic surface modifier, and covering a part or entirety of the surface of the metal oxide particles with the fluorine-based anionic surface modifier, and
mixing the metal oxide particles whose surface is partially or completely covered with the fluorine-based anionic surface modifier and the binder polymer.
